(19) United States
(12) Patent Application Publication
(10) Pub. No.: US 2011/0170964 A1
(43) Pub. Date: Jul. 14, 2011

(54) DRILLING TOOL AND DEVICE WITH SELF-MAINTAINED AXIAL VIBRATIONS

(75) Inventors: Patrice Rabaté, Ermont (FR); George-Florin Moraru, Aix-en-Provence (FR); Daniel Brun Picard, Six-Fours-Ies-Plages (FR)

(73) Assignees: European Aerronautic And Space Company Eads France, Paris (FR); Ecole Nationale Superieure D'Arts Et Metiers, Aix-en-Provence (FR); Centre National De La Recherche, Paris (FR)

(21) Appl. No.: 12/300,466

(22) PCT Filed: May 10, 2007
(86) PCT No.: PCT/EP2007/054531

§ 371 Date: Nov. 3, 2010

(30) Foreign Application Priority Data
May 17, 2006 (FR) 06 51773

(51) Int. Cl. B23B 47/34

(52) U.S. Cl. 408/17

(57) ABSTRACT

In order to effect drilling without any risk of blockage of the cutting tool used, a drilling device uses means for producing a self-maintained axial vibration of the tool that has the effect of breaking up the swarf of the material removed from the hole in order to facilitate discharge thereof. The means for producing the self-maintained axial vibration are also such that the spindle of the tool can have a direction substantially different from the rotation axis of the means used for rotating the tool. Such a device is particularly advantageous for producing deep holes or during the use of cutting tools producing asymmetric cutting forces. In a particularly advantageous embodiment, the means for producing the self-maintained axial vibration and for enabling the rotation axis of the tool to have a direction substantially different from the rotation axis of the drive means form part of the cutting tool.

### CROSS REFERENCE TO RELATED APPLICATIONS

This application is the National Stage of International Application No. PCT/EP2007/054531 International Filing Date, 10 May 2007, which designated the United States of America, and which International Application was published under PCT Article 21 (2) as WO Publication No. WO2007/131936 and which claims priority from French Application No. 0651773, filed on 17 May 2006, the disclosures of which are incorporated herein by reference in their entireties.

### BACKGROUND

1. Field

The disclosed embodiments belong to the field of drilling of materials and more particularly to the drilling of deep holes by means of cutting tools.

2. Brief Description of Related Developments

During drilling of a material by using a cutting tool such as a drill, said cutting tool generates swarf of matter removed from the material.

It is well known that this swarf must be evacuated from the hole during drilling in order to avoid the stuffing of the cutting tool, a stuffing which would cause a quick deterioration of the cutting properties of the tool and a degradation of the hole precision and of the surface quality of the hole wall during execution. In the most unfavorable cases, the stuffing can cause the blocking and rupture of the tool with serious consequences for the workpiece during drilling and the production cycles of said workpiece. These problems become particularly critical during the realization of deep holes for which the natural evacuation of the swarf is difficult.

Several techniques are used to reduce these risks.

In particular it is known to try to split the swarf in order to facilitate its evacuation by traditional means such as by the helical grooves of the cutting tool and or by blowing of air or lubricant in the center of the tool.

In order to split the swarf produced by the cutting tool, the tool is regularly disengaged from the material by an axial backward movement relative to the drilling advancement direction before taking again the advancement in the drilling direction.

A first technique consists to force a periodic backward axial movement of the tool, superimposed to the direction of the advancement movement of drilling, by an adapted mechanism, but this imposed movement generates, when the tool returns in contact with the matter to continue drilling, repeated shocks which quickly cause degradations of the tool characteristics.

A second technique described in the French patent application published under the number 2 765 505 consists to fix the tool on a tool holder coupled to a drilling head comprising means to provide the axial guidance of the tool holder relative to the support of the drilling head and translation coupling means which may be deformed in axial translation so that the tool can vibrate along the axial direction under the effect of the forces generated by drilling. By fitting the characteristics of the elastic elements to the mass of the cutting tool and the tool holder and to the cutting parameters, the axial vibrations are maintained by excitations generated by the drilling operation itself.

To ensure the axial displacement associated with the tool vibration, the axial guiding means maintain the tool axis superimposed with the drilling head axis. These means take the shape of two crowns spaced along the drilling head axis and which deform themselves in the axis direction without authorizing any radial displacements nor variation of the tool axis direction relative to the drilling head axis. In another provided embodiment these axial guiding means comprises a ball groove integral with the drilling head into which the tool holder slides in the direction of the rotation axis, also without authorizing variation between the tool axis direction and that of the drilling head axis.

Such means are mechanically complex and lead to a significant increase on the dimensions and the fragility of the drilling head, in particular due to the vibrations maintained by the device and the sensitivity of the axial guiding means to radial efforts. Moreover the guiding means are sources of frictions which disturb the self-maintained vibratory operation very sensitive to the changes of the device parameters and said guiding means require to carry out specific drilling heads that may require significant changes on the drilling devices and the machining procedure associated to the drillings.

The use of twist drills, due to the symmetry of the radial efforts applied by this type of drills on the drilling head, makes it possible to limit the friction forces into the axial guiding means which are induced by the radial efforts.

However, this sensitivity becomes critical when are used drills including only one cutting edge, named drills 3/4, and or that the drillings are deep relative to the diameter of said drilling. In the case of the drill 3/4, the guidance is not correctly ensured by the drilling head because the radial efforts on the tool caused by the drilling operation are not any more symmetrical. The drills 3/4 are used to carry out drillings and borings of high degrees of accuracy and quality such as they are required for example for the assemblies of heavily charged structures in aeronautical engineering.

### SUMMARY

The disclosed embodiments provide a drilling device with self-maintained axial vibrations for the generation of short swarf which notably makes it possible, without any problem, to use the drills 3/4 for the realization of drillings of high accuracy and which includes simple and robust means adaptable on the majority of the existing machines to carry out this type of drillings.

Advantageously the means of said drilling head are adaptable on existing drilling units without notable change of said drilling units.

To carry out such a drilling with self-maintained vibrations, a drilling device includes

a rotation driving unit including an output shaft rotated about an axis,

a cutting tool with a rotation axis,

means for coupling the cutting tool with the output shaft,

The coupling means are ready to transmit the driving torque to the cutting tool and include elastic means suited to cause a self-maintained axial vibration of the cutting tool during a drilling operation. Moreover the coupling means are arranged to allow an angular difference between the cutting tool axis direction and the output shaft axis direction under the effect of radial forces applied to the cutting tool during the drilling operation in order to avoid the hyperstatic configuration which would be generated by an assembly of the tool in which the tool axis direction would be imposed relative to the driving shaft direction.

To rotate the tool without imposing the direction of said tool, the coupling means include a first end element provided with means to ensure the connection to the output shaft of the driving unit, a second end element provided with means to fix the tool and include, between said first and second end elements, an intermediate zone rigid in torsion, elastic along an axial direction and flexible under flexion forces.

In a particular embodiment the intermediate zone includes first means rigid in torsion, elastic along the axial direction and flexible under flexion forces and includes second separate means elastic along the axial direction.

In order to ensure the transmission of the couple during drilling and to leave the possibility of displacements of the tool along its axis and of angular displacement of the tool axis relative to the output shaft axis, the first means of the intermediate zone comprise at least three arms arranged in a non-radial way between a first crown integral with the first end element and a second crown integral with the second end element.

Spring means ready to be compressed between seating faces of the first and second end elements cause the self-maintained axial vibration of the tool. Advantageously the first and second end elements and the intermediate zone means are shaped to avoid direct contacts between said first and second end elements during the drilling operation.

In another embodiment, the intermediate zone includes an element elastic into an axial direction, which is also ready to transmit the drilling torsional forces and ready to deform itself under flexion forces during the rotation of the tool in order to allow the direction of the axis of said tool to be different from that of the output shaft axis.

Such an element elastic along an axis and ready to transmit the movement of the tool when said tool is not aligned with the driving shaft advantageously includes at least three coaxial crowns into a elastic material having substantially the same dimensions and arranged as a stack. Each crown is spaced from its neighboring crown and is connected to said neighboring crown by means of two connecting elements laid out along a ray of the crowns and radially opposite, and wherein the two connecting elements laid out on one face of a crown are moreover laid out along a ray substantially perpendicular to the ray defined by the two connecting elements laid out to the other face of the crown. In such a rigid in torsion about an axis corresponding to the crowns axis arrangement, the deformation of the crowns provides the required axial elasticity whereas the deformation of the connections allows the deformation under flexion forces.

In an alternative embodiment, the intermediate zone includes at least two crowns kept coaxial and spaced by at least two elongated connecting elements into a elastic material, each connecting element being fixed on a first crown by one end of said connecting element and being fixed at the second crown by a second end of said connecting element at a point shifted by an angle corresponding to a rotation angle of the crowns about their axis relative to the point to which the first end is secured to the first crown. In this case the deformation under flexion forces of the connecting elements provides the elasticity sought along the axis and the flexibility required to the deformation under flexion forces.

Advantageously a metallic material such as a steel is used for its properties as elastic material and the intermediate zone and the end zones are made integral by machining of a material block.

The disclosed embodiments relate also to a cutting tool for drilling which includes:

a first end cutting, including a rotation axis, ready to carry out a drilling by removal of swarf of the material to be bored,

a second end, including a rotation axis, intended to be coupled with rotation driving means about said axis,

and which includes between the two ends a connecting zone:

ready to transmit the drilling torsional forces,

ready to deform itself substantially along the axis of the tool in an elastic way and to create a self-maintained vibration of the end of said tool along its axis under the effect of the forces created by the drilling operation,

ready to deform itself under flexion forces during the rotation of the tool to allow the axis of the cutting end of said tool and the axis of the second end to form ansome angle δ.

Thus, it is possible to carry out a drilling with self-maintained axial vibration without using particular driving means and to have cutting tool adaptable on conventional driving means. The characteristics of the connecting zone are adapted to the cutting tool which makes it possible to avoid the use of adjustment means.

The detailed description of an embodiment is made with reference to the figures which present:

### BRIEF DESCRIPTION OF THE DRAWINGS

FIG. 1: an example of principle of driving means to which a cutting tool is coupled and including a tool advance device;

FIG. 2: an example of a first embodiment of coupling means for coupling the cutting tool to an output shaft of the driving means, with FIG. 2a being a cross-section of the assembled coupling means and FIG. 2b a perspective exploded view of the elements of said coupling means;

FIG. 3: photographs reproduction of matter swarf produced by conventional drilling operations—FIG. 3a—and by using the device according to the disclosed embodiments—FIG. 3b—;

FIG. 4: an example of a second embodiment of the coupling means with a perspective view of said means—FIG. 4a—, a detail in perspective of an intermediate zone of said means—FIG. 4b—, a developed view of the surface of said intermediate zone showing an example of form for the openings at external surface of said intermediate zone—FIG. 4c—, and an illustration on a cross-section with a removed quarter of the deformation of said intermediate zone under loads—FIG. 4d—;

FIG. 5: an example of a second form of the intermediate zone with a perspective detail of an intermediate zone of said means—FIG. 5a—, and a developed view of the surface of said intermediate zone showing an example of form for the openings at the external surface of said intermediate zone—FIG. 5b—;

FIG. 6: a view of a tool according to the disclosed embodiments.

### DETAILED DESCRIPTION OF THE DISCLOSED EMBODIMENTS

A drilling device with self-maintained axial vibration includes driving means 1 including an output shaft 2 rotated by said driving means about a rotation axis 3.

At an accessible end 4 of the output shaft 2, a cutting tool 5 having a rotation axis 6 is secured by means of a tool support 7 so that the tool axis 6 is substantially in the prolongation of the output shaft axis 3 and that the tool 5 is rotated by the rotation of the output shaft 2.

During a drilling operation, tool 5 is moved with an axial movement so that an end 51 of said tool penetrates in the workpiece 8 into which the drilling must be carried out. This displacement D, or advance movement, is carried out by an advance device 9 of the driving means which provides the commanded displacement of the output shaft 2 end 4 relative to a support structure 11 of driving means.

The advance movement can also be carried out by a relative displacement between the workpiece 8 and the driving means 1.

The tool support 7 includes a first element 71 ready to be secured by one end 712 to the driving means 1 output shaft 2 to be rotated and includes a second element 72 ready to maintain by one end 724 the cutting tool 5 end opposed to end 51 which penetrates into the workpiece 8.

Said first and second elements 71, 72 cooperate by means of a third element 73 including an external crown 74 and an internal crown 75 connected by at least three arms 76. The external crown 74 is integral with the first element 71, for example by means of screws 731, and the internal crown 75 is integral with the second element 72, for example by means of a tightening nut 732.

In a static position, when the assembled device is not subjected to any particular external force, the axis 3 of output shaft 2, when the end 412 of the first element 71 is secured to said output shaft, and the axis 7 of tool 5, when it is secured at the end 724 of second element 72, are substantially aligned.

The at least three arms 76 connecting the crowns 74, 75 are arranged in a way substantially different from rays, i.e. that they do not converge towards a common point in order to be able to rotate the second element 72 by arms 76 during the rotation of the first element 71 so that said arms are primarily constrained under traction to increase the transmissible couple and so that second element 72 can on one side move with an axial translation movement relative to first element 71 and can on the other side move with an angular movement so that axis 7 of the tool, when the tool is assembled on said second element, and the axis 3 of the output shaft, when said first element is connected to said shaft, can have different directions during the rotational movement about axes 3, 7 of the output shaft and of the tool. In addition to their arrangement between the crowns 74, 75, the at least three arms are made of a material, for example a steel, having the mechanical strength and flexibility characteristics required to transmit the rotation forces and to undergo the necessary deformations taking into account the amplitudes sought for the axial and angular movements.

The axial and angular displacements amplitudes of the second element 72 relative to the first element 71 are limited by the shape and dimensions of arms 76, but in the practice, the realization of the third element 73 including said arms does not raise any particular difficulty because the required amplitudes are low. Said amplitudes, variables according to the device dimensions, are generally about some tenth of millimeter for axial displacements and lower than one degree for angular displacements.

Elastic means 77, for example a spring working in compression, are laid out between the first and second elements 71, 72. Said elastic means seat on a face 711 of the first element and on a face 721 of the second element.

When a pressure is exerted on tool 5 during the drilling operation, the second element 72 to which the tool is secured moves in a direction opposed to the advance movement D of the tool by deforming arms 76 of third element 73 and compresses the elastic means 77 between the seating faces 711, 721 of the first and second elements.

Advantageously the elastic means 77 are maintained in position substantially along the first and second elements 71, 72 axis by means of a protuberance, for example a protuberance 722 of the second element 72 substantially in the axis of said element, around which are placed the elastic means.

By its conformation and its dimensions, the form 722 authorizes axial translations and angular relative movements between the first and second elements without interference. Gaps 723 are in particular left between the first and second elements 71, 72 so that the axial translations movements are realized without any friction and that the angular movements do not generate any risk of wedging.

The orientation of the cutting tool 5 axis 6 not being imposed by the driving means which do not include any axial guidance of the tool, the tool end 51 on the side of the workpiece 8 to be bored is guided.

The guidance is carried out for example by means of a drilling jig 10 which is positioned relative to workpiece 8 to be bored by means of a support such as a drill grid (not represented). In an alternative way, guidance is carried out by means of a partial drilling of the workpiece allowing a centering and an initial guidance of the cutting tool 5 which is then guided during drilling by the hole under realization.

For a given cutting tool and a material into which a drilling must be carried out, the choice of the cutting parameters, tool revolution number and advance in particular, and of an fitted stiffness of elastic means 77 causes an axial vibration of the cutting tool maintained by the cutting forces and the natural instabilities of drilling.

As in any vibrating mechanical system, the mass of the mobile unit is a parameter which influences the vibratory conditions and it may be necessary to adjust the mass of the cutting tool or the vibrating unit, for example by means of added masses, so that the axial vibratory movement be initiated and self-maintained during a particular drilling operation.

The amplitude of this self-maintained axial vibration leads to a splitting of the swarf removed by the cutting tool at its end 51.

The splitting of the swarf can be obtained by an amplitude of the axial vibration such that the tool is temporarily released from the matter of the workpiece, which occurs when the tool vibrates along its axis with an amplitude substantially equal or higher than the distance covered by the advance device of the tool during one cycle of the axial vibration.

The splitting of the swarf can also be obtained with a vibration amplitude lower but sufficient so that the thickness of the swarf is sufficiently reduced when the tool is in the least engaged position into the matter so that the weakened swarf break naturally during the drilling operation. The implementation of this vibratory operating mode is preferred to prevent that the tool be damaged by an entry into the matter of the workpiece at each cycle of the axial vibration.

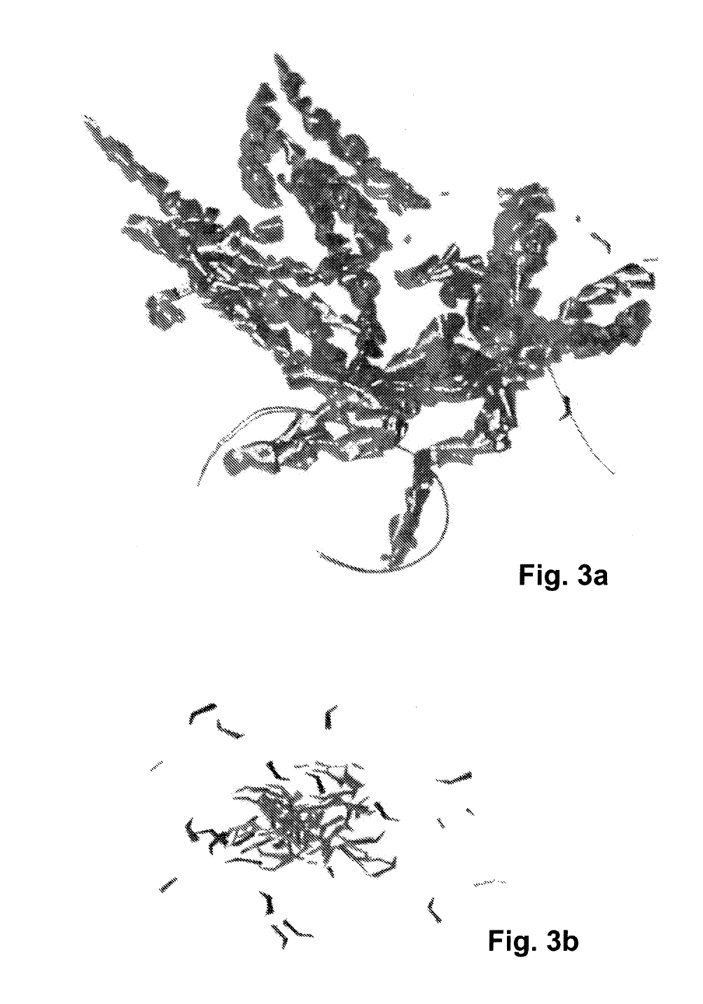

The photography of FIG. 3b shows split swarf produced during a drilling operation realized with a device with self-maintained axial vibration according to the disclosed embodiments which are compared to swarf of the photography of FIG. 3a, having substantially the same of enlargement ratio, carried out during a conventional drilling operation.

In another embodiment the tool support 7 is carried out by means of a single element 12 in a substantially cylindrical form. The single element 12 includes at one of its ends 121 means for securing driving means 1 to the output shaft 2 and at its other end 122 means for securing the cutting tool 5.

Advantageously said securing means are compatible with those of the driving means and the existing tools.

Between the ends 121, 122, the tool support 12 includes an intermediate zone 123 shaped to obtain the elasticity characteristics in compression sought for the elastic means associated to the vibratory axial displacement of the tool and the flexibility characteristics under flexion forces sought to make it possible the tool axis to be deviated at some angle, in particular under the effect of forces applied to the cutting tool 5.

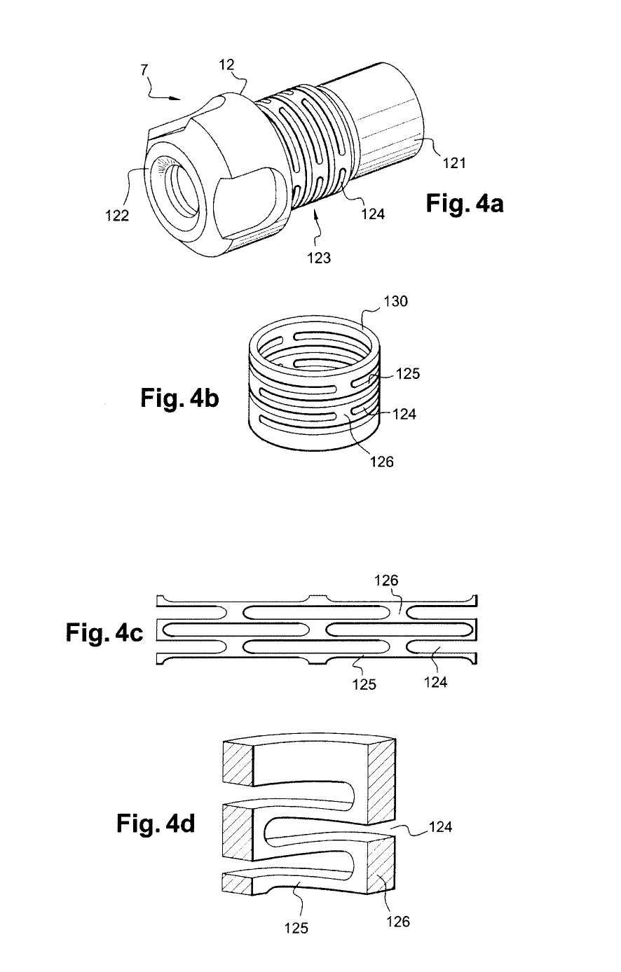

This intermediate zone 123, which must moreover transmit the torsional forces, is advantageously formed by a hollow cylindrical segment of circular section, as illustrated on FIG. 4b, made in a elastic material, for example in a steel, and whose wall 130 includes openings 124 defining a structure of the intermediate zone 123 comparable to a stacking of crowns 125 maintained spaced by spacers 126 mounted by pairs diametrically opposite between two crowns and disposed at 90 degrees between the 2 faces of a crown. Advantageously the intermediate zone 123 is carried out by machining a block of material in which the ends 121, 122 are also machined. FIG. 4c illustrates the aspect of the external surface of the intermediate zone 123 developed on a plane.

This arrangement allows

to transmit the couple of the driving means 1 to the cutting tool 5 because the structure of the intermediate zone 123 is very rigid in torsion;

to form an elastic connection in the direction of the output shaft axis or the tool axis by deformation of the crowns 125 between studs 126, as illustrated in the example of FIG. 4d cross-section, and whose stiffness is, in particular, given by the number and the thickness of said crowns;

to transmit the rotational movement when axis 6 of the tool is not exactly in the direction of the output shaft axis 3, the intermediate element functioning in this case as an assembly of the Cardan joint type.

Other forms of the intermediate zone 123 are usable at the condition that they satisfy the three requirements of transmission of the drilling couple, elasticity along the tool axis and of possibility of angular deformation between the driving shaft axis and the tool axis.

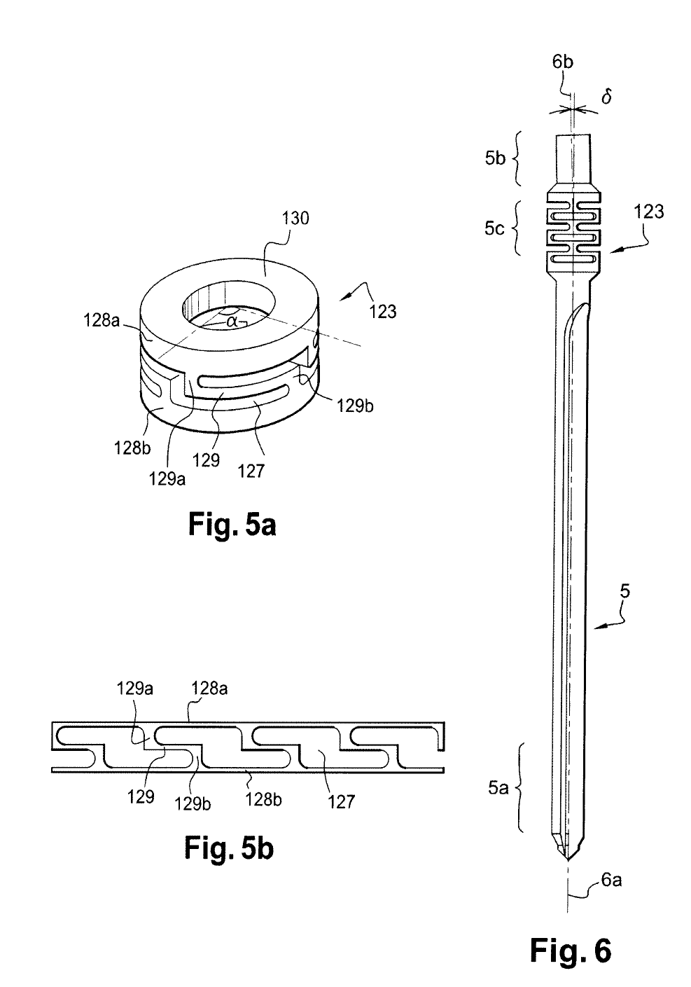

The drawings of the FIGS. 5a and 5b illustrate another possible arrangement of openings 127 into the wall 130 of the intermediate zone 123 ready to restore the capacities sought for said intermediate zone. The FIG. 5b illustrates the shape of the openings on the external surface of the intermediate zone developed along a plane. In this particular embodiment, the intermediate zone 123 includes at least two crowns 128a, 128b connected by matter bridges 129. Each matter bridge 129 is connected to the first crown 128a by a first end 129a and is connected to the second crown 128b by its second end 129b in a point of said second crown shifted relative to the connecting point with said first crown by an angle corresponding to a rotation angle around the driving axis, for example of 90 degrees.

The elasticity characteristics of the matter bridges 129, relating to the material used for their realization and to their forms, make it possible to obtain the required stiffness. If necessary, several crowns connected by bridges are juxtaposed by construction of the intermediate zone 123.

In a particular embodiment of the device, the tool holder is a conventional and rigid connecting means and the means to allow the axial and angular displacements of the tool are integral parts of the cutting tool.

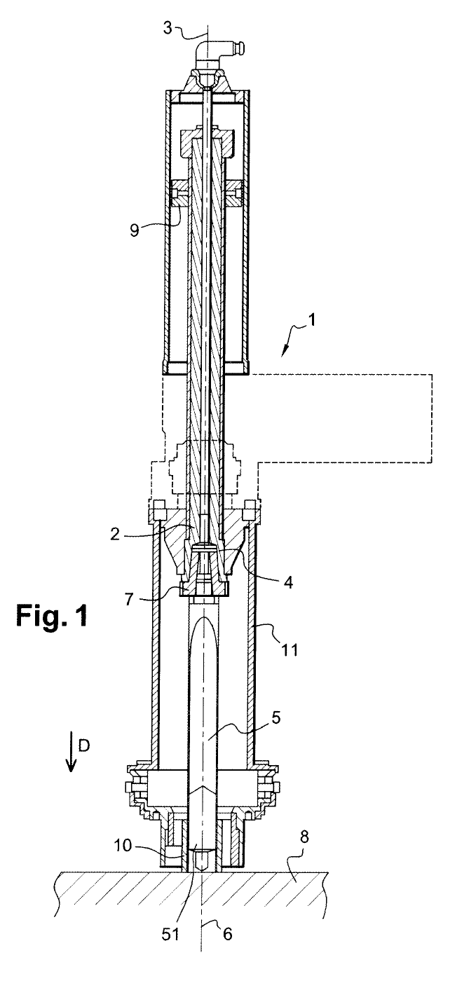

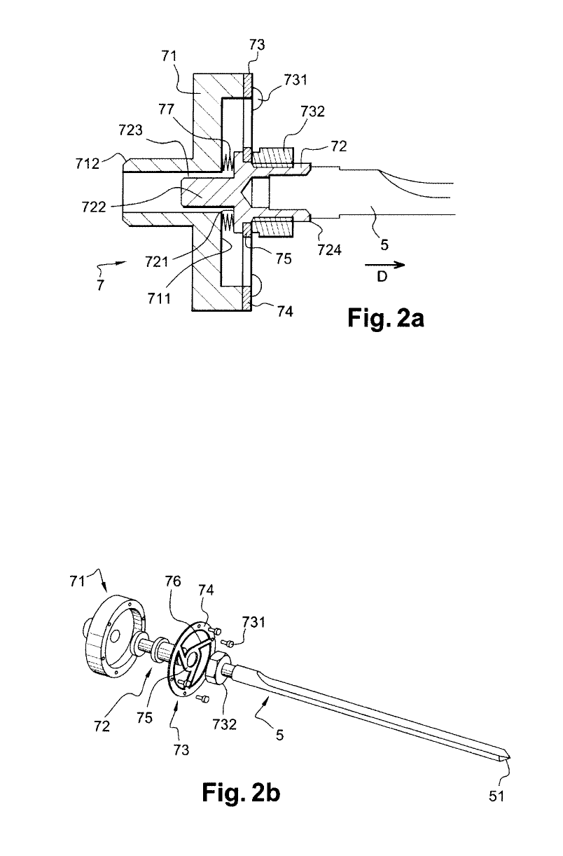

Such a cutting tool 5, shown on FIG. 6, includes between an end 5a, ready to carry out a drilling by swarf matter removal by rotation about an axis 6a, and an end 5b, ready to be rotated about an axis 6b by driving means, such as for example those presented on FIG. 1, a connecting zone 5c:

ready to deform itself in an elastic way to cause a self-maintained axial vibration of the cutting end 5a of tool 5,

ready to transmit the couple necessary to drive the tool 5,

ready to deform itself under flexion forces to allow the axis 6a of the tool cutting end 5a and the axis 6b of the end 5b driven by the rotation driving means to form an angle δ.

Advantageously the connecting zone 5c includes means similar to those of the intermediate zone 123 of the tool support previously described.

This embodiment is particularly advantageous because, without requiring to modify the existing driving means, on one side the intermediate zone 123 is carried out according to the particular characteristics of the tool and the cutting parameters considered, which characteristics influence the auto-excited vibratory behavior of the tool, and on the other side the utilization period of the intermediate zone 123 is limited by the lifetime of the cutting tool into which it is integrated, which has the effect to avoid or substantially limit the risk of rupture in fatigue of said intermediate zone, highly constrained by vibration and stresses, during the drilling operations.

The intermediate zone 123 can be carried out by machining during the realization of the tool 5. The tool can also be produced by an assembly, for example by welding, of various elements.

In a particular embodiment, not represented, an intermediate zone similar to the intermediate zone 123 of the tool support previously described, is arranged on the output shaft 2, near the end on which is connected a tool support or a tool.

The disclosed embodiments thus make it possible to carry out drillings by producing split swarf, easy to evacuate by conventional means, for example blowing and or suction means, including with drills producing nonsymmetrical cutting forces relative to the drilling axis, such as the drills including only one cutting edge named drills 3/4, without any axial guidance of the tool at the level of the rotation driving means of the tool.

Moreover the disclosed embodiments make it possible to carry out drillings with self-maintained axial vibration of the tool without any changes on the existing driving mechanisms.

1. A drilling device comprising:
a rotation driving unit including an output shaft rotated about an axis,
a cutting tool with a rotation axis,
coupling means of the cutting tool with the output shaft,
wherein the coupling means are ready to transmit the driving torque to the cutting tool and include elastic means suited to cause a self-maintained axial vibration of said cutting tool during a drilling operation, characterized in that said coupling means are arranged to allow an angular difference between the axis direction of the cutting tool and the axis direction of the output shaft under the effect of radial forces applied to the cutting tool during the drilling operation.

2. A drilling device according to claim 1 wherein the coupling means includes a first end element provided with means to ensure the connection to the output shaft of the driving unit, a second end element provided with means to fix the tool and includes an intermediate zone between said first and second end elements, said intermediate zone being rigid in torsion, elastic along an axial direction and flexible under flexion forces.

3. A drilling device according to claim 2 wherein the intermediate zone includes first rigid in torsion, elastic along the axial direction and flexible under flexion forces means and includes second means, separate from the first means, elastic along the axial direction.

4. A drilling device according to claim 3 wherein the first means of the intermediate zone include at least three arms arranged in a non-radial way between one first crown integral with the first end element and a second crown integral with the second end element.

5. A drilling device according to claim 3 wherein the second means of the intermediate zone include spring means ready to be compressed between seating faces of the first and second end elements.

6. A drilling device according to claim 2 wherein the first and second end elements and the intermediate zone means are shaped to avoid direct contacts between said first and second end elements during the drilling operation.

7. A drilling device according to claim 2 wherein the intermediate zone includes an element elastic along an axial direction, said elastic element being ready to transmit the drilling torsional forces and said element being ready to deform itself under flexion forces during the rotation of the tool in order to allow the axis direction of said tool to be different from that of the axis of the output shaft.

8. A drilling device according to claim 7 wherein the intermediate zone includes at least three coaxial crowns into a elastic material having substantially the same dimensions and arranged as a stack, each crown being spaced from its neighboring crown and connected to said neighboring crown by means of two connecting elements laid out along a ray of the crowns and radially opposite, and wherein the two connecting elements laid out on one face of a crown are moreover laid out along a ray of the crowns substantially perpendicular to the ray defined by the two connecting elements laid out on the other face of the crown.

9. A drilling device according to claim 7 wherein the intermediate zone includes at least two crowns kept coaxial and spaced by at least two elongated connecting elements into a elastic material, each connecting element being fixed on a first crown by one end of said connecting element and being fixed on the second crown by a second end of said connecting element at a point shifted by an angle corresponding to a rotation angle of the crowns about their axis relative to the point to which the first end is secured to the first crown.

10. A drilling device according to claim 8 wherein the elastic material is a metallic material such as a steel.

11. A drilling device according to claim 8 wherein the intermediate zone and the end zones are made integral by machining of a material block.

12. A cutting tool for drilling including:
a first cutting end, including a rotation axis, ready to carry out a drilling by removal of swarf of the material to be bored,
a second end, including a rotation axis, intended to be coupled with rotation driving means about said axis,
wherein it includes between the two ends a connecting zone;
ready to transmit the drilling torsional forces,
said zone being ready to deform itself substantially along the axis of the tool in an elastic way and to create a self-maintained vibration of the end of said tool along its axis under the effect of the forces created by the drilling operation,
said zone being ready to deform itself under flexion forces during the rotation of the tool to allow the axis of the cutting end of said tool and the axis of the second end to form some angle.

13. A cutting tool for drilling according to claim 12 whose connecting zone includes a section in conformity with an intermediate zone according to one of claims 8 to 11.

14. A cutting tool for drilling according to claim 12 wherein the elasticity characteristics of the connecting zone are defined for specific conditions of cutting parameters and of material to bore in order to generate self-maintained axial oscillations of the cutting end of the tool for said specific conditions.
